(19) United States
(12) Patent Application Publication
(10) Pub. No.: US 2022/0115176 A1
(43) Pub. Date: Apr. 14, 2022

(54) Laminated Electronic Device and Manufacturing Method Thereof

(71) Applicant: Shenzhen Sunlord Electronics Co., Ltd., Shenzhen (CN)

(72) Inventors: Dafu LU, Shenzhen (CN); Jieyong QIN, Shenzhen (CN); Zhenren LIANG, Shenzhen (CN); Shuyan LI, Shenzhen (CN)

(73) Assignee: Shenzhen Sunlord Electronics Co., Ltd., Shenzhen (CN)

(21) Appl. No.: 17/412,228

(22) Filed: Aug. 25, 2021

Related U.S. Application Data
(63) Continuation of application No. PCT/CN2020/120386, filed on Oct. 12, 2020.

(51) Int. Cl. H01F 27/28; H01F 27/29; H01F 41/04; H01F 41/10

(52) U.S. Cl. CPC H01F 27/2804; H01F 27/292; H01F 2027/2809; H01F 41/10; H01F 41/041

(57) ABSTRACT

A laminated electronic device includes a laminate wherein the laminate includes a plurality of laminated insulator layers, the laminate has a multi-layer coil pattern provided between the plurality of insulator layers in a laminated manner, adjacent layers of the coil pattern are electrically connected through conductive via holes to form an internal coil, a first external electrode and a second external electrode are disposed on a bottom surface of the laminate which is parallel to a direction of lamination. In surface-mounting of the laminated electronic device, it only needs to connect the external electrodes on the bottom surface of the laminate to a soldering board, and needs not to preserve a space for solder wicking in the surrounding, thereby significantly saving the occupied space of surface mount components to achieve high-density mounting; in addition, the Q value of the product is improved.

### CROSS REFERENCE TO RELATED APPLICATIONS

This application is a continuation application of PCT/CN2020/120386 filed on 2020 Oct. 12. The contents of the above-mentioned application are all hereby incorporated by reference.

### BACKGROUND OF THE INVENTION

### 1. Field of the Invention

The present application relates to electronic devices, and more particularly, to a laminated electronic device and a manufacturing method thereof.

### 2. Description of the Prior Art

In recent years, with the increasing popularity of wearable devices, new devices, such as smart bracelets, Bluetooth earphones, etc., have begun to be accepted by people, and due to the small size and rich functions of such devices, they require miniaturization and high density of electronic components and electronic circuits.

As the smart phone has more and more functions and people requires for better battery life, space for the components is gradually reduced. In order to meet the needs of customers, a large number of components need to be arranged in a limited space, so the miniaturization of the components and high-density placement of the components in the limited space are an inevitable trend of future development.

At present, the minimum size of chip inductors is metric 0201, and the minimum size of chip magnetic beads is metric 0402. With the current technology, it is necessary to seek new technological breakthroughs if we want to develop to a smaller size. Therefore, from the components themselves, it is relatively difficult to reduce the size of the components in a short time, and the space that can be reduced is also very limited.

However, in order to meet the needs for miniaturization and multi-functionalization of intelligent devices, it is considered to start from the density of placement of the components, and high-density mounting is adopted to improve the space utilization and reduce the space occupation ratio of components, so as to meet the development trend of intelligent devices.

A conventional inductor or magnetic bead component with an internal electrode structure is usually provided with a C-shaped terminal electrode or an L-shaped terminal electrode. FIG. 1 shows a schematic view illustrating the structure of a conventional C-shaped external electrode component, with an external terminal electrode structure 13 provided at the entire terminal of the component. FIG. 2 shows a schematic view illustrating the structure of an L-shaped external electrode device with external terminal electrode structures 14 provided on both sides of the device. According to the conventional external terminal electrode structures, in surface mounting, a space needs to preserved for solder wicking, which may occupy a certain space on the circuit board, and the density of placement of the circuit board is influenced.

The above disclosed background art is only used for assisting in understanding the inventive concept and technical solution of the present application, and does not necessarily belong to the prior art of the present application. Insofar as no explicit evidence indicates that the above-mentioned contents have been disclosed on the filing date of the present application, the above-mentioned background art should not be used for evaluating the novelty and inventive step of the present application.

### SUMMARY OF THE INVENTION

An object of the present application is to solve the defects in the prior art, and provides a laminated electronic device and a manufacturing method thereof, so as to save the occupied space of surface mount components to achieve high-density mounting and improve the space utilization.

In order to achieve the above object, the present application adopts the following technical solution:

A laminated electronic device, including a laminate, an internal coil, a first external electrode, and a second external electrode, wherein the laminate comprises a plurality of laminated insulator layers, the laminate has a multi-layer coil pattern provided between the plurality of insulator layers in a laminated manner, the plurality of insulator layers are provided with conductive via holes, adjacent layers of the coil pattern are electrically connected through the conductive via holes to form the internal coil, the first external electrode and the second external electrode are disposed on a bottom surface of the laminate which is parallel to a direction of lamination, and the first external electrode and the second external electrode are connected to two ends of the internal coil, respectively.

Further, the internal coil formed by the multiple layers of the coil pattern electrically connected with each other is a spiral coil.

Further, the insulator layer includes a plurality of first insulating layers and a plurality of second insulating layers, the first insulating layers are provided with the coil pattern and the conductive via holes, the second insulating layers are only provided with the conductive via holes without the coil pattern, the second insulating layers and the first insulating layers are in alternate arrangement, and adjacent layers of the coil pattern are electrically connected through the conductive via holes in the first insulating layers and the second insulating layers.

Further, the first external electrode includes a plurality of first electrode strips which are pre-formed on a first side of a bottom end of the plurality of insulator layers, and the plurality of first electrode strips are laminated together to jointly form the first external electrode; and the second external electrode includes a plurality of second electrode strips which are pre-formed on a second side of the bottom end of the plurality of insulator layers, and the plurality of second electrode strips are laminated together to jointly form the second external electrode.

Further, the first side and the second side of the bottom end of the plurality of insulator layers are configured as recesses, and the plurality of first electrode strip layers and the plurality of second electrode strip layers just fill up the recesses so that the bottom surface of the laminate provided with the first external electrode and the second external electrode becomes a flat surface.

Further, each of the first external electrode and the second external electrode is an external electrode integrally formed on the bottom surface of the laminate.

A method for manufacturing a laminated electronic device, including the following steps of:

laminating a plurality of insulator layers to form a laminate, wherein a multi-layer coil pattern is provided between the plurality of insulator layers in a laminated manner, the plurality of insulator layers are provided with conductive via holes, and adjacent layers of the coil pattern are electrically connected through the conductive via holes to form an internal coil; and forming a first external electrode and a second external electrode on a bottom surface of the laminate which is parallel to a direction of lamination, with the first external electrode and the second external electrode connected to two ends of the internal coil, respectively.

Further, before the laminating a plurality of insulator layers to form a laminate, the method further includes the following steps of: forming a plurality of first electrode strips on a first side of a bottom end of the plurality of insulator layers, and forming a plurality of second electrode strips on a second side of the bottom end of the plurality of insulator layers; wherein the step of forming a first external electrode and a second external electrode on a bottom surface of the laminate which is parallel to a direction of lamination is performed by the step of laminating a plurality of insulator layers to form a laminate, wherein the plurality of first electrode strips are laminated together to jointly form the first external electrode, and the plurality of second electrode strips are laminated together to jointly form the second external electrode.

Further, the forming a plurality of first electrode strips on a first side of a bottom end of the plurality of insulator layers, and forming a plurality of second electrode strips on a second side of the bottom end of the plurality of insulator layers, specifically includes the following steps of: providing recesses on the first side and the second side of the bottom end of the plurality of insulator layers; and forming the plurality of first electrode strip layers and the plurality of second electrode strip layers on the first side and the second side, respectively, of the bottom end of the plurality of insulator layers in a manner of just filling up the recesses so that the bottom surface of the laminate provided with the first external electrode and the second external electrode becomes a flat surface.

Further, the forming a first external electrode and a second external electrode on a bottom surface of the laminate which is parallel to a direction of lamination, specifically includes the following steps of: after the forming a plurality of insulator layers to form a laminate, forming the first external electrode and the second external electrode on the bottom surface of the laminate.

The present application has the following beneficial effects: the laminated electronic device provided by the present application includes a laminate formed by a plurality of laminated insulator layers, an internal coil formed by a multi-layer coil pattern provided between the plurality of insulator layers and electrically connected to each other through conductive via holes provided in the plurality of insulator layers, and a first external electrode and a second external electrode which are connected to two ends of the internal coil, respectively, and are disposed on a bottom surface of the laminate which is parallel to a direction of lamination, i.e., the first external electrode and the second external electrode serve as bottom electrodes disposed on the same bottom surface perpendicular to the insulator layers and the internal coil, and the two ends of the internal coil of the laminate are led out through the bottom electrodes, so that in surface-mounting of the laminated electronic device, it only needs to connect the bottom electrodes to a soldering board, and needs not to preserve a space for solder wicking in the surrounding so as to allow seamless placement of the components, thereby significantly saving the occupied space of surface mount components to achieve high-density mounting. Compared with the conventional C-shaped external electrode component or L-shaped external electrode component, the laminated electronic device provided by the present application has the external electrodes disposed on the bottom surface of the device without extending to other surfaces, so that the size of surface-mount solder joints can be reduced to not exceed the size of the components, and seamless displacement of the components is achieved so as to improve the space utilization to the maximum extent. Meanwhile, by means of the structural design that the internal coil is perpendicular to the bottom electrodes, the stray capacitance of the product can be effectively reduced, thereby improving the Q value of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic view illustrating the structure of a conventional laminated electronic device having a C-shaped external electrode component;

FIG. 2 shows a schematic view illustrating the structure of a conventional laminated electronic device having an L-shaped external electrode component;

FIG. 3 shows a schematic view illustrating the structure of a laminated electronic device according to a first embodiment of the present application;

FIG. 4 shows an exploded view of the laminated electronic device according to the first embodiment of the present application;

FIG. 5 shows a schematic view illustrating the structure of a laminated electronic device according to a second embodiment of the present application; and

FIG. 6 shows an exploded view of the laminated electronic device according to the second embodiment of the present application.

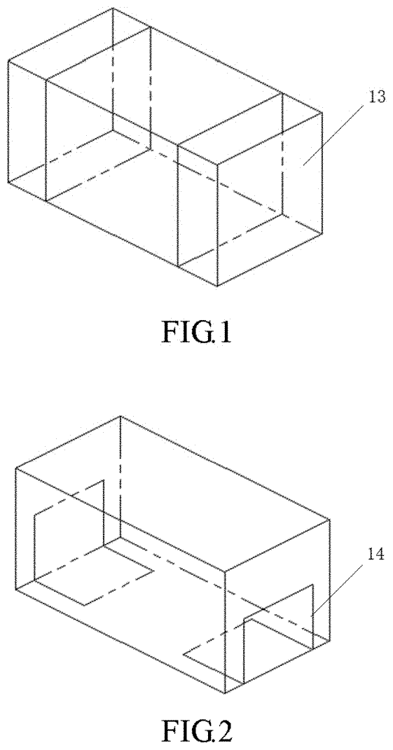

### DETAILED DESCRIPTION

The embodiments of the present invention will be described in detail below. It should be noted that the following description is exemplary only and is not intended to limit the scope of the present application and its use.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element. In addition, the connection may be for either fixation or coupling or communication.

It is to be understood that the terms “length, width, upper, lower, front, rear, left, right, vertical, horizontal, top, bottom, inner, outer”, and the like, refer to orientations or positional relationships based on the orientations or positional relationships shown in the figures. It is merely for the purpose of describing the embodiments of the present application and of simplifying the description, and is not intended to indicate or imply that a particular orientation, configuration and operation of the referenced device or element is necessary, and thus should not be construed as limiting the present application.

Furthermore, the terms “first” and “second” are used for descriptive purposes only and are not to be construed as indicating or implying relative importance or implicitly indicating the number of technical features indicated. Thus, features defining “first” and “second” may explicitly or implicitly include one or more such features. In the description of the embodiments herein, “a plurality of” means two or more, unless specifically defined otherwise.

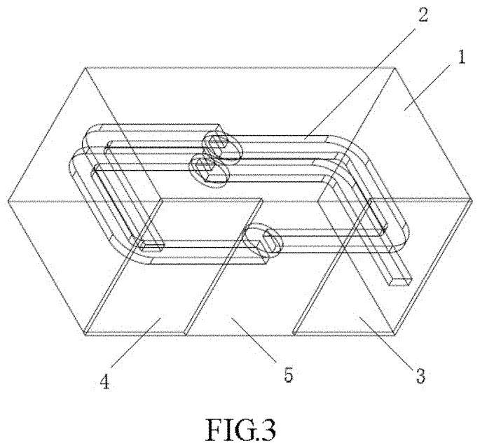

Referring to FIGS. 3 to 6, an embodiment of the present application provides a laminated electronic device, including a laminate 1, an internal coil 2, a first external electrode 3, and a second external electrode 4, the laminate 1 includes a plurality of laminated insulator layers, the laminate 1 has a multi-layer coil pattern 8 provided between the plurality of insulator layers in a laminated manner, the plurality of insulator layers are provided with conductive via holes 9, adjacent layers of the coil pattern 8 are electrically connected through the conductive via holes 9 to form the internal coil 2, the first external electrode 3 and the second external electrode 4 are disposed on a bottom surface 5 of the laminate 1 which is parallel to a direction of lamination, and the first external electrode 3 and the second external electrode 4 are connected to two ends of the internal coil 2, respectively.

In this embodiment, the first external electrode 3 and the second external electrode 4 are disposed on the same bottom surface 5 perpendicular to the insulator layers and the internal coil 2 to serve as bottom electrodes, and the two ends of the internal coil 2 of the laminate 1 are led out through the bottom electrodes, so that in surface-mounting of the laminated electronic device, it only needs to connect the bottom electrodes to a soldering board, and needs not to preserve a space for solder wicking in the surrounding so as to allow seamless placement of the components, thereby significantly saving the occupied space of surface mount components to achieve high-density mounting. Compared with the conventional C-shaped external electrode component or L-shaped external electrode component, the laminated electronic device provided by the present application has the external electrodes disposed on the bottom surface of the device without extending to other surfaces, so that the size of surface-mount solder joints can be reduced to not exceed the size of the components, and seamless displacement of the components is achieved so as to improve the space utilization to the maximum extent. Meanwhile, by means of the structural design that the internal coil is perpendicular to the bottom electrodes, the stray capacitance of the product can be effectively reduced, thereby improving the Q value of the product.

In this embodiment, the conductive materials used for the first external electrode 3 and the second external electrode 4 and the internal coil 2 are not limited. Preferably, the first external electrode 3 and the second external electrode 4 are made of a conductive material as same as the internal coil 2.

Referring to FIGS. 3 and 5, in some embodiments, the multiple layers of the coil pattern 8 are electrically connected with each other to form a spiral coil. When viewed in the direction of lamination of the laminate 1, the internal coil 2 includes multiple layers of the conductor pattern overlapped with each other to form a spiral coil, adjacent layers of the conductor pattern are electrically connected through via holes in the insulator layers, and the two ends of the spiral coil are led out from the same bottom surface of the laminate 1.

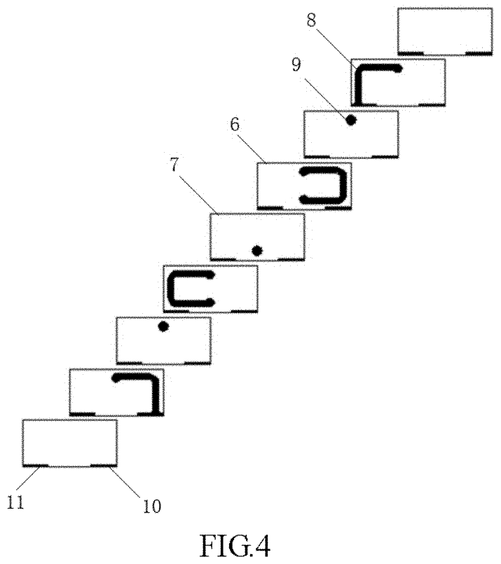

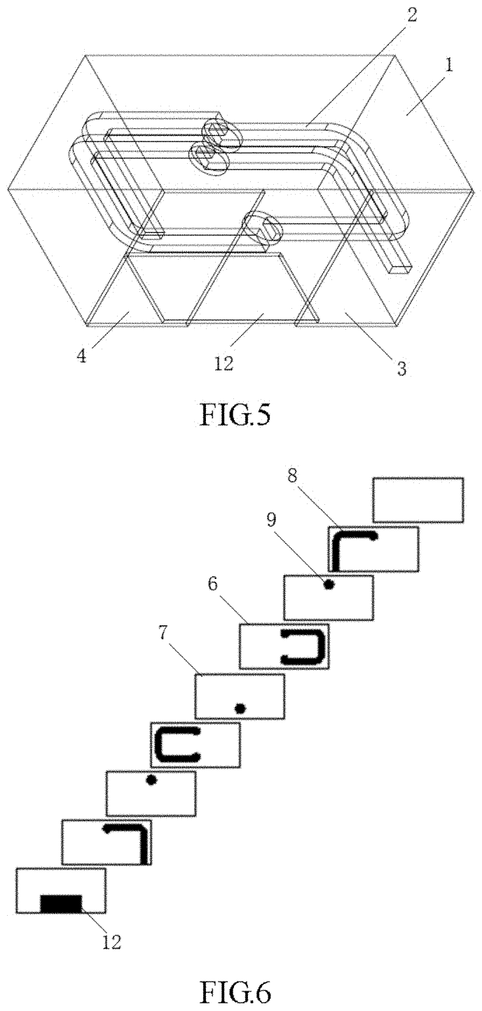

Referring to FIGS. 4 and 6, in a preferred embodiment, the insulator layer includes a plurality of first insulating layers 6 and a plurality of second insulating layers 7, the first insulating layers 6 are provided with the coil pattern 8 and the conductive via holes 9, the second insulating layers 7 are only provided with the conductive via holes 9 without the coil pattern 8, the second insulating layers 7 and the first insulating layers 6 are in alternate arrangement, and adjacent layers of the coil pattern 8 are electrically connected through the conductive via holes 9 in the first insulating layers 6 and the second insulating layers 7.

As shown in FIGS. 3 and 4, in a preferred embodiment, the first external electrode 3 includes a plurality of first electrode strips 10 which are pre-formed on a first side of a bottom end of the plurality of insulator layers, and the plurality of first electrode strips 10 are laminated together to jointly form the first external electrode 3; and the second external electrode 4 includes a plurality of second electrode strips 11 which are pre-formed on a second side of the bottom end of the plurality of insulator layers, and the plurality of second electrode strips 11 are laminated together to jointly form the second external electrode 4.

In this embodiment, the terminals of the internal coil 2 are led out perpendicularly to the bottom of the laminated electronic device, and are connected to the external electrodes provided on the bottom which are disposed on the bottom without extending to other surfaces.

In this embodiment, the bottom electrodes of the laminated electronic device are created during blank shaping, and the bottom electrodes are assembled while the insulator layers are laminated, so that it does not needs to produce the bottom electrodes after lamination of the insulator layers and blank shaping, and therefore direction marks do not need to be provided on the laminated electronic device to identify the direction of the device.

As shown in FIGS. 3 and 4, in a more preferred embodiment, the first side and the second side of the bottom end of the plurality of insulator layers are configured as recesses, and the plurality of first electrode strip 10 layers and the plurality of second electrode strip 11 layers just fill up the recesses so that the bottom surface of the laminate 1 provided with the first external electrode 3 and the second external electrode 4 becomes a flat surface. Such structure of this embodiment allows the first external electrode 3 and the second external electrode 4 to be embedded in the laminate 1, leaving only the soldering surface exposed to the outside of the laminate 1. This embodiment provides a structure in which the external electrodes are disposed inside the laminate 1 with the soldering surfaces of the external electrodes exposed to the outside of the laminate, which facilitates subsequent soldering and mounting of the electronic device.

Referring to FIGS. 5 and 6, in some other embodiments, each of the first external electrode 3 and the second external electrode 4 is an external electrode integrally formed on the bottom surface of the laminate 1. In this embodiment, the terminals of the internal coil 2 are led out perpendicularly to the bottom of the laminated electronic device, and are connected to the external electrodes provided on the bottom which are disposed on the bottom without extending to other surfaces. The external electrode may be projected from the bottom surface, one side of the external electrode is connected to a lead-out end of the internal coil 2 of the laminate 1, and other sides of the external electrode are exposed to the outside of the laminate 1. The external electrodes may be made by a product silver coating process. In order to facilitate identification of the direction of the device, a direction mark 12 is provided on the surface of the laminate 1, which may be arranged on a side surface of the laminate 1.

Referring to FIGS. 3 to 6, an embodiment of the present application further provides a method for manufacturing a laminated electronic device, including the following steps: a plurality of insulator layers are laminated to form a laminate 1, wherein a multi-layer coil pattern 8 is provided between the plurality of insulator layers in a laminated manner, the plurality of insulator layers are provided with conductive via holes 9, and adjacent layers of the coil pattern 8 are electrically connected through the conductive via holes 9 to form an internal coil 2; and a first external electrode 3 and a second external electrode 4 are formed on a bottom surface 5 of the laminate 1 which is parallel to a direction of lamination, with the first external electrode 3 and the second external electrode 4 connected to two ends of the internal coil 2, respectively.

In surface-mounting of the laminated electronic device manufactured according to this embodiment, it only needs to connect the external electrodes on the bottom of the laminated electronic device to a soldering board, and needs not to preserve a space for solder wicking in the surrounding so as to allow seamless placement of the components, thereby significantly saving the occupied space of surface mount components to achieve high-density mounting. Compared with the conventional C-shaped external electrode component or L-shaped external electrode component, the laminated electronic device provided by the present application has the external electrodes disposed on the bottom surface of the device without extending to other surfaces, so that the size of surface-mount solder joints can be reduced to not exceed the size of the components, and seamless displacement of the components is achieved so as to improve the space utilization to the maximum extent.

Referring to FIGS. 3 and 4, in a preferred embodiment, before a plurality of insulator layers are laminated to form a laminate 1, the method further includes the following steps: a plurality of first electrode strips 10 are formed on a first side of a bottom end of the plurality of insulator layers, and a plurality of second electrode strips 11 are formed on a second side of the bottom end of the plurality of insulator layers; wherein the step that a first external electrode 3 and a second external electrode 4 are formed on a bottom surface of the laminate 1 which is parallel to a direction of lamination is performed by the step that a plurality of insulator layers are laminated to form a laminate 1, wherein the plurality of first electrode strips 10 are laminated together to jointly form the first external electrode 3, and the plurality of second electrode strips 11 are laminated together to jointly form the second external electrode 4.

In this embodiment, the bottom electrodes of the laminated electronic device are created during blank shaping, and the bottom electrodes are assembled while the insulator layers are laminated, so that it does not needs to produce the bottom electrodes after lamination of the insulator layers and blank shaping, and therefore direction marks do not need to be provided on the laminated electronic device to identify the direction of the device.

Referring to FIGS. 3 and 4, in a more preferred embodiment, the step that a plurality of first electrode strips 10 are formed on a first side of a bottom end of the plurality of insulator layers, and a plurality of second electrode strips 11 are formed on a second side of the bottom end of the plurality of insulator layers, specifically includes the following steps: recesses are provided on the first side and the second side of the bottom end of the plurality of insulator layers; and the plurality of first electrode strip 10 layers and the plurality of second electrode strip 11 layers are formed on the first side and the second side, respectively, of the bottom end of the plurality of insulator layers in a manner of just filling up the recesses so that the bottom surface of the laminate 1 provided with the first external electrode 3 and the second external electrode 4 becomes a flat surface.

By adopting the manufacturing method of the embodiment, such structure of this embodiment allows the first external electrode 3 and the second external electrode 4 to be embedded in the laminate 1, leaving only the soldering surface exposed to the outside of the laminate 1.

Referring to FIGS. 5 and 6, in some other embodiments, the step that a first external electrode 3 and a second external electrode 4 are formed on a bottom surface of the laminate 1 which is parallel to a direction of lamination, specifically includes the following steps: after a plurality of insulator layers are laminated to form a laminate 1, the first external electrode 3 and the second external electrode 4 are formed on the bottom surface 5 of the laminate 1.

Specifically, in manufacturing, the external electrode may be projected from the bottom surface, one side of the external electrode is connected to a lead-out end of the internal coil 2 of the laminate 1, and other sides of the external electrode are exposed to the outside of the laminate 1. The external electrodes may be made by a product silver coating process. In order to facilitate identification of the direction of the device, a direction mark 12 is provided on the surface of the laminate 1, which may be arranged on a side surface of the laminate 1.

The background section of the present application may contain background information regarding the problem or environment of the present application and does not necessarily describe the prior art. Therefore, the content contained in the background section is not the applicant's recognition of the prior art.

The foregoing is a further detailed description of the present application, taken in conjunction with specific/preferred embodiments, and is not to be construed as limiting the specific embodiments of the present application. It will be apparent to those skilled in the art to which this application pertains that many alternatives or modifications to the described embodiments may be devised without departing from the spirit thereof, and all such alternatives or modifications are deemed to be within the scope of this application. In the description of this specification, reference to the description of the terms “an embodiment”, “some embodiments”, “preferred embodiments”, “examples”, “specific examples”, or “some examples”, etc., means that particular features, structures, materials, or characteristics described in connection with the embodiment or example is included in at least one embodiment or example of the application. In the present description, schematic representations of the above terms are not necessarily directed to the same embodiments or examples. Furthermore, the particular features, structures, materials, or characteristics described may be combined in any one or more embodiments or examples in a suitable manner. Moreover, various embodiments or examples described in this description, as well as features of various embodiments or examples, may be incorporated and combined by those skilled in the art without departing from the scope of the application. Although embodiments of the present application and advantages thereof have been described in detail, it should be understood that various changes, substitutions and alterations can be made herein without departing from the scope of the application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A laminated electronic device, comprising:
a laminate, an internal coil, a first external electrode, and a second external electrode, wherein the laminate comprises a plurality of laminated insulator layers, the laminate has a multi-layer coil pattern provided between the plurality of insulator layers in a laminated manner, the plurality of insulator layers are provided with conductive via holes, adjacent layers of the coil pattern are electrically connected through the conductive via holes to form the internal coil, the first external electrode and the second external electrode are disposed on a bottom surface of the laminate which is parallel to a direction of lamination, and the first external electrode and the second external electrode are connected to two ends of the internal coil, respectively.

2. The laminated electronic device of claim 1, wherein the internal coil formed by the multiple layers of the coil pattern electrically connected with each other is a spiral coil.

3. The laminated electronic device of claim 1, wherein the insulator layer comprises a plurality of first insulating layers and a plurality of second insulating layers, the first insulating layers are provided with the coil pattern and the conductive via holes, the second insulating layers are only provided with the conductive via holes without the coil pattern, the second insulating layers and the first insulating layers are in alternate arrangement, and adjacent layers of the coil pattern are electrically connected through the conductive via holes in the first insulating layers and the second insulating layers.

4. The laminated electronic device of claim 1, wherein the first external electrode comprises a plurality of first electrode strips which are pre-formed on a first side of a bottom end of the plurality of insulator layers, and the plurality of first electrode strips are laminated together to jointly form the first external electrode; and the second external electrode comprises a plurality of second electrode strips which are pre-formed on a second side of the bottom end of the plurality of insulator layers, and the plurality of second electrode strips are laminated together to jointly form the second external electrode.

5. The laminated electronic device of claim 4, wherein the first side and the second side of the bottom end of the plurality of insulator layers are configured as recesses, and the plurality of first electrode strip layers and the plurality of second electrode strip layers just fill up the recesses so that the bottom surface of the laminate provided with the first external electrode and the second external electrode becomes a flat surface.

6. The laminated electronic device of claim 1, wherein each of the first external electrode and the second external electrode is an external electrode integrally formed on the bottom surface of the laminate.

7. A method for manufacturing a laminated electronic device, comprising the following steps of:
laminating a plurality of insulator layers to form a laminate, wherein a multi-layer coil pattern is provided between the plurality of insulator layers in a laminated manner, the plurality of insulator layers are provided with conductive via holes, and adjacent layers of the coil pattern are electrically connected through the conductive via holes to form an internal coil; and
forming a first external electrode and a second external electrode on a bottom surface of the laminate which is parallel to a direction of lamination, with the first external electrode and the second external electrode connected to two ends of the internal coil, respectively.

8. The method for manufacturing a laminated electronic device of claim 7, wherein before the laminating a plurality of insulator layers to form a laminate, the method further comprises the following steps of:
forming a plurality of first electrode strips on a first side of a bottom end of the plurality of insulator layers, and forming a plurality of second electrode strips on a second side of the bottom end of the plurality of insulator layers;
wherein the step of forming a first external electrode and a second external electrode on a bottom surface of the laminate which is parallel to a direction of lamination is performed by the step of laminating a plurality of insulator layers to form a laminate, wherein the plurality of first electrode strips are laminated together to jointly form the first external electrode, and the plurality of second electrode strips are laminated together to jointly form the second external electrode.

9. The method for manufacturing a laminated electronic device of claim 8, wherein the forming a plurality of first electrode strips on a first side of a bottom end of the plurality of insulator layers, and forming a plurality of second electrode strips on a second side of the bottom end of the plurality of insulator layers, specifically comprises the following steps of:
providing recesses on the first side and the second side of the bottom end of the plurality of insulator layers; and
forming the plurality of first electrode strip layers and the plurality of second electrode strip layers on the first side and the second side, respectively, of the bottom end of the plurality of insulator layers in a manner of just filling up the recesses so that the bottom surface of the laminate provided with the first external electrode and the second external electrode becomes a flat surface.

10. The method for manufacturing a laminated electronic device of claim 7, wherein the forming a first external electrode and a second external electrode on a bottom surface of the laminate which is parallel to a direction of lamination, specifically comprises the following steps of.
after the forming a plurality of insulator layers to form a laminate, forming the first external electrode and the second external electrode on the bottom surface of the laminate.
